(19) United States
(12) Patent Application Publication
(10) Pub. No.: US 2008/0091338 A1
(43) Pub. Date: Apr. 17, 2008

(54) Navigation System And Indicator Image Display System

(76) Inventor: Kazutake Uehira, Tokyo (JP)

Correspondence Address: ARENT FOX LLP, 1050 CONNECTICUT AVENUE, N.W., SUITE 400, WASHINGTON, DC, 20036, US

(21) Appl. No.: 11/631,193

(22) PCT Filed: Jul. 1, 2005
(86) PCT No.: PCT/JP05/12214

§ 371 Date: Dec. 29, 2006

(30) Foreign Application Priority Data
Jul. 2, 2004 (JP) 2004-196958

(51) Int. Cl. G01C 21/34; B60K 35/00; G08G 1/0969; G09B 29/00; G09G 5/00

(52) U.S. Cl. 701/200; 345/9

(57) ABSTRACT

A route guidance method for displaying to a driver depth information within a range of several tens of meters to several hundreds of meters in a forward direction indispensable for route guidance of a mobile object without introducing a large scale optical system and a route guidance system using the same are provided as an object. A navigation system for displaying an image (including graphics, letters, and symbols) 5 so that it overlaps a view seen in a forward direction of a front window 3 provided in a mobile object 100, wherein the image 5 is displayed to the driver while changing a size of the image 5 along with the elapse along with movement of the mobile object 100.

### TECHNICAL FIELD

The present invention relates to a navigation system and an indicator image display system mounted in a mobile object such as an automobile.

### BACKGROUND ART

A conventional navigation system acquires a present location by utilizing a GPS (global positioning system) and, at the same time, retrieves map information in the vicinity of the present location stored in a storage medium such as a DVD from the storage medium, displays it on a vehicle-mounted display, and indicates a route from the present location of the vehicle to an destination on the map to thereby provide route guidance (navigation).

In this method, the vehicle-mounted display is frequently arranged at part of the front panel, but is not arranged in the forward field of vision of a driver, therefore the driver frequently move his line of sight to the vehicle-mounted display and a safety hazard arises. Further, in route guidance using a map, a comparison between the map and the actual surroundings is necessary. It is difficult to instantaneously determine the route by viewing the map. This becomes a demerit particularly while driving.

Therefore, audio guidance is provided while driving, but this guidance consists of, for example, “turn right after about 300 meters” and “turn left soon”, i.e., does not enable correct route guidance. Particularly in a case where there are adjoining intersections within 20 to 30 meters and so on, there is a problem that the driver cannot judge which intersection is designated.

As a method for solving this problem, Patent Document 1 discloses a technique of reading stereo map information in the vicinity of the present location of the vehicle to prepare a bird's eye view and projecting the bird's eye view onto a heads up display so that it overlaps the view as seen through the front window.

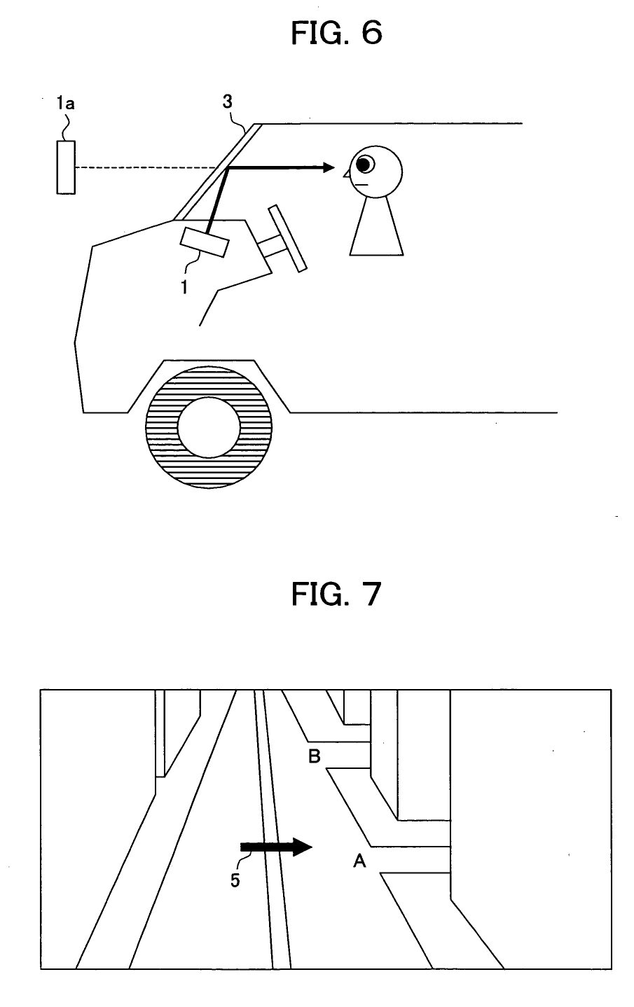

A heads up display, as shown in FIG. 6, is a display that reflects the image displayed on a display 1 at a front window 3 to allow the driver to see the image from the driver's seat and consequently allow the driver to see the image from the driver seat as if the forward view through the front window 3 and a displayed image 1a of the display 1 overlapped. By using such a heads up display, the problem of the driver moving his line of sight in order to view displayed graphic shown on the vehicle-mounted display can be solved. However, route instruction was not considered in Patent Document 1, so this was insufficient as a navigation system.

On the other hand, Patent Document 2 discloses a method of acquiring the present location and traveling direction of the vehicle, estimating a view seen from the front window based on the present location and traveling direction and the stereo geographic information, generating a route instruction graphic relating to the features in the estimated view, projecting it onto the heads up display so that it appears at the vicinity of the related features in the view seen from the front window, and thereby performing the route guidance.

FIG. 7 illustrates the view beyond the front window as seen by the driver and the route instruction graphic according to this method. On the front window 3, the actual view and a course guidance graphic such as a route instruction graphic 5 overlap. By displaying a see-through image overlapping the actual view, the process of the driver of finding the correspondence between the position on the map and the view seen in front through the front window becomes unnecessary, so the driver can quickly grasp the route and finds it easier to drive.

Patent Document 3 discloses a navigation system using a heads up display for performing a three-dimensional display. This is used for the purpose of three-dimensionally displaying a map which has been conventionally been displayed two-dimensionally. This mentions nothing concerning route guidance displaying a route instruction graphic.

Patent Document 1: Japanese Patent Publication (A) No. 4-125679

Patent Document 2: Japanese Patent Publication (A) No. 9-35177

Patent Document 3: Japanese Patent Publication (A) No. 2003-4462

### DISCLOSURE OF THE INVENTION

### Problem to be Solved by the Invention

In the method according to Patent Document 2, the route instruction graphic is projected onto the heads up display so that it is seen in the vicinity of the related features in the view seen from the front window. The view seen from the front window is that of a three-dimensional space, while the image displayed by the heads up display is a two-dimensional image. Therefore, the view seen from the front window is regarded as a two-dimensional space by ignoring the depth, and the route instruction graphic is displayed in the vicinity of the related features in the two-dimensional space.

In this case, however, the following problem occurs.

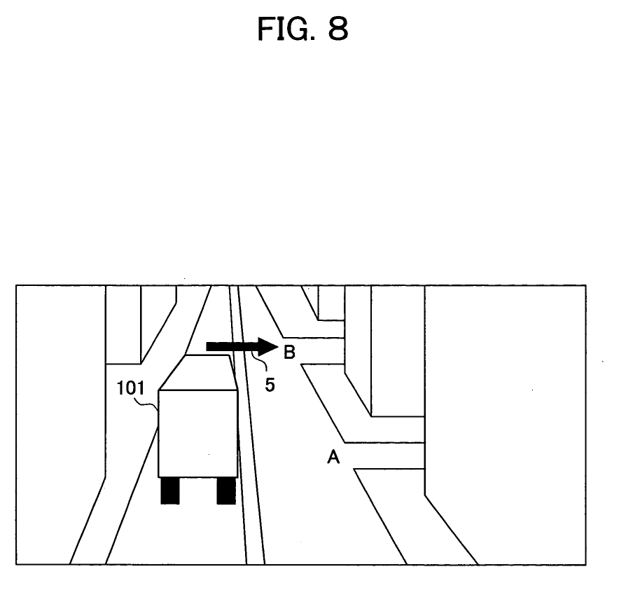

For example, as shown in FIG. 7, if the route instruction graphic 5 such as “turn right at the intersection A” is displayed so that it overlaps the road surface of the intersection A, it is easily understood, but if a large vehicle 101 is traveling just in front of the vehicle, it must be displayed above the road surface by a few meters for safety, so the route instruction graphic 5 is displayed above the road surface by a few meters as shown in FIG. 8. In that case, there arises the problem that the driver no longer can distinguish whether the route instruction graphic 5 designates the intersection A or designates an intersection B. This problem occurs since the disclosed heads up display uses a two-dimensional image having no depth information in the displayed image.

In general, when considering the fact that traffic lights and many road signs are disposed above the road surface by a few meters, it is indispensable that the route instruction graphic in the route guidance system also be able to be displayed above the road surface. Accordingly, solution of the above problem is indispensable.

Therefore, use of the heads up display enabling three-dimensional display as disclosed in Patent Document 3 in a navigation system can be considered, but the above problem is not solved for the following reasons.

Three-dimensional displays which have been put into practical use hitherto utilize a binocular vision using a binocular parallax. With a binocular vision using such a binocular parallax, the difference of depths can be perceived only within a range up to a few meters in the forward direction at most.

However, in the route guidance of a mobile object, it is necessary to express the difference of depths within a range of from several tens of meters to several hundreds of meters in the forward direction. Nevertheless, in the three-dimensional displays which have been put into practical use hitherto, for example an intersection ahead by 100 meters and an intersection ahead by 150 meters cannot be distinguished.

Note that, even in a two-dimensional display, the above problem can be solved so long as the location ahead from the front window in the depth direction where the route instruction graphic is seen, that is, the location of the virtual image, is 100 m or more ahead and the location of the virtual image can be made variable. However, this is possible in principle, but it is necessary to introduce a large optical system between the display and the front window for both the formation of the virtual image 100 m or more ahead and making the location of the virtual image variable. In practice it is realistically difficult to secure such a space in an ordinary vehicle.

In such a situation, an object of the present invention is to solve the problem described above and provide a navigation system optimum for route guidance.

### Means for Solving the Problem

A first aspect of the present invention is a navigation system displaying an image (including graphics, letters, and symbols) so as to overlap a view seen in a forward direction of a front window provided in a mobile object wherein the image is displayed to a driver while changing a size of at least one graphic (including symbols and letters) in the image along with the elapse along with movement of the mobile object.

A second aspect of the present invention is a navigation system forming an image of a displayed image of a display mounted in a mobile object on a front window provided in the mobile object on an opposite side to a driver's seat so as to display the displayed image of the display to the driver of the mobile object, wherein the image is displayed to a driver while changing a size of at least one graphic (including symbols and letters) in the image along with the elapse along with movement of the mobile object.

According to a third aspect of the present invention, there is provided a navigation system reflecting a part of light emitted from a display surface of a display mounted in the mobile object at a front window of the mobile object and forming a virtual image of the displayed image of the display in the direction ahead of the front window so as to display the image to the driver of the mobile object, wherein the image is displayed to a driver while changing a size of at least one graphic (including symbols and letters) in the image along with the elapse along with movement of the mobile object.

Preferably, the size of said graphic is calculated based on position information of the mobile object.

Preferably, the size of said graphic is calculated based on the position information of the mobile object and a movement speed of the mobile object.

Preferably, the position of formation of said graphic is a position 10 meters or more ahead of the front window provided in the mobile object in the forward direction.

A fourth aspect of the present invention is an indicator image display system enabling a user in a mobile object to view an indicator image by overlapping the indicator image on the view of the surroundings of said mobile object as seen through a transparent member, provided with an image generation unit generating said indicator image, a display system displaying the indicator image generated by said image generation unit and overlapping said indicator image on the view of the surroundings of said mobile object on said transparent member so that the indicator image and a landmark feature seen through said transparent member have a constant positional relationship, and a processing unit computing a distance from said mobile object to said landmark feature and controlling an operation of at least one of said image generation unit and said display system so as to increase the size of said indicator image overlapped on said transparent member along with a reduction of said computed distance along with movement of said mobile object.

A fifth aspect of the present invention is an indicator image display system enabling a user in a mobile object to view an indicator image by overlapping the indicator image on the view of the surroundings of said mobile object seen through a transparent member, provided with an image generation unit generating said indicator image, a display system displaying the indicator image generated by said image generation unit and overlapping said indicator image on the view of the surroundings of said mobile object on said transparent member so that the indicator image and a landmark feature seen through said transparent member have a constant positional relationship, and a processing unit computing a distance from said mobile object to said landmark feature and controlling an operation of at least one of said image generation unit and said display system so as to reduce the size of said indicator image overlapped on said transparent member along with an increase of said computed distance along with movement of said mobile object.

Preferably, said processing unit controls the operation of at least one of said image generation unit and said display system so that the display of said indicator image is started when the distance from said mobile object to said landmark feature becomes within a predetermined threshold value and so that the size of said indicator image when the display is started becomes constant.

Preferably, provision is further made of a storage unit storing a basic pattern of said indicator image, and said processing unit controls the operation of at least one of said image generation unit and said display system so as to generate an image having a size of the size of said basic pattern multiplied by a ratio of the distance from said mobile object to said landmark feature with respect to said threshold value.

Preferably, said processing unit controls the operation of at least one of said image generation unit and said display system so as to display said indicator image when the distance to said landmark feature is within a predetermined threshold value, and said threshold value is a position away from said transparent member by 10 meters or more.

### EFFECT OF THE INVENTION

According to the navigation system according to the present invention, the driver is allowed to easily perceive depth position information of a route instruction graphic etc. by utilizing a motion parallax, which is one of the depth perception factors of the human visual system, which is able to perceive a difference of depths within the range from several tens of meters to several hundreds of meters indispensable for correct route guidance while movement of a mobile object, so as to instantaneously display the route guidance information while movement to the driver. Further, the utilization of the motion parallax has the feature that no special three-dimensional display system is needed since depth position information of a route instruction graphic etc. perceived by a driver is determined by the rate of change of the position and size in the field of view along with the elapse irrespective of the actual image position so long as the position of the image is at least a certain distance away from the driver and has the action of increasing driving safety since the driver does not take his eyes off the road ahead in order to obtain the route guidance information, so exhibits remarkable effects.

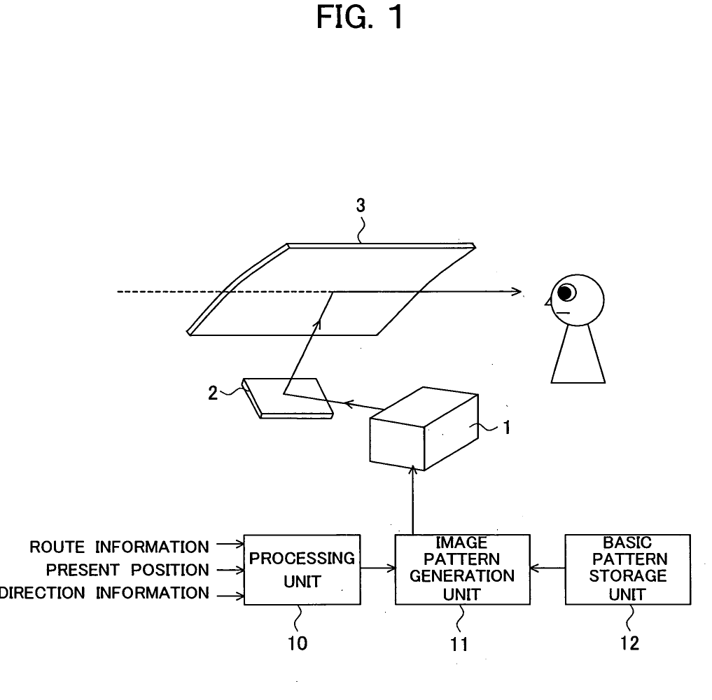

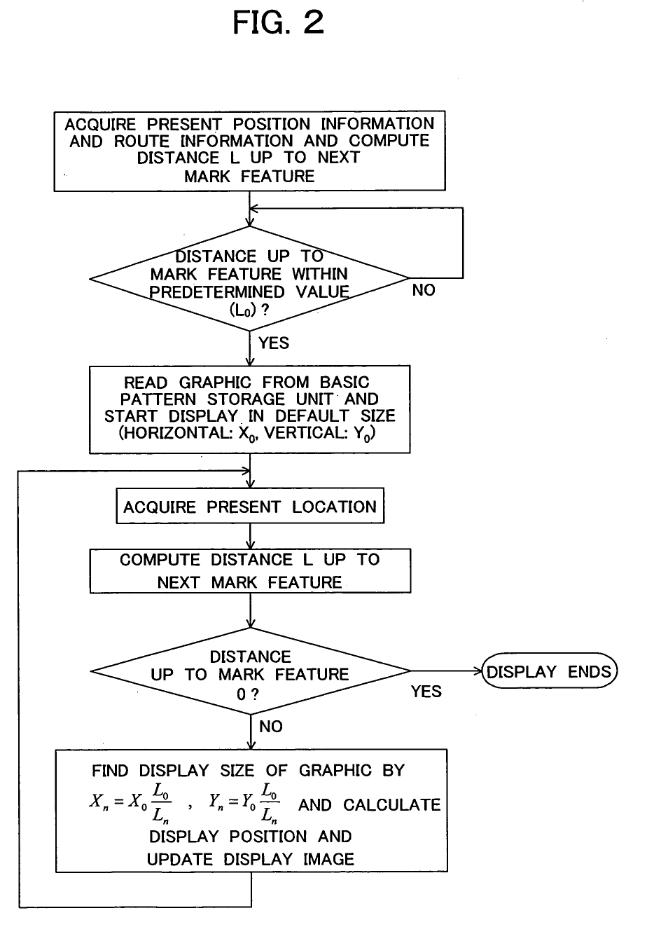

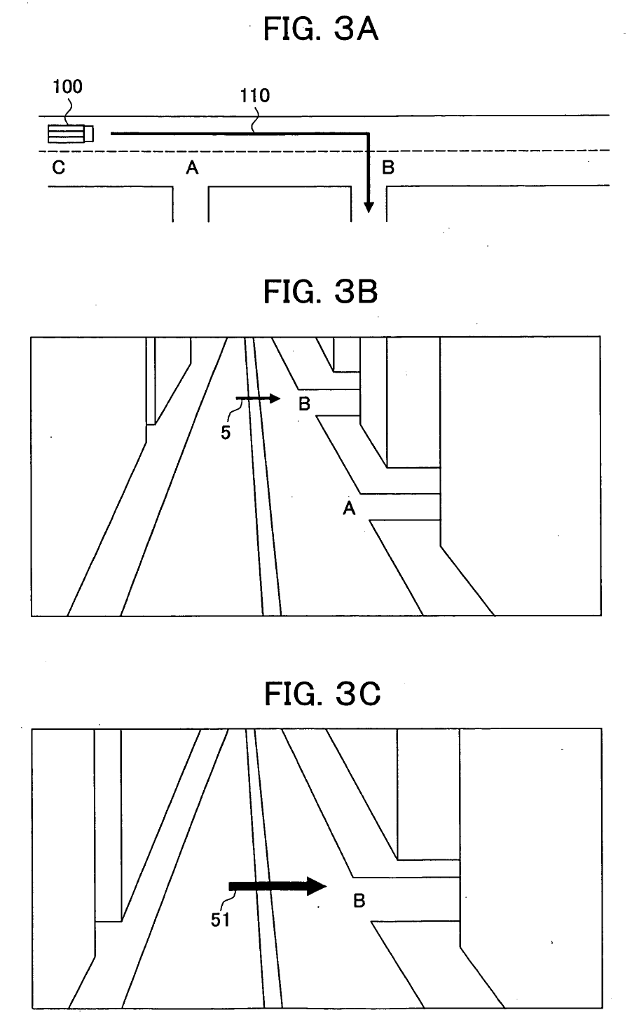

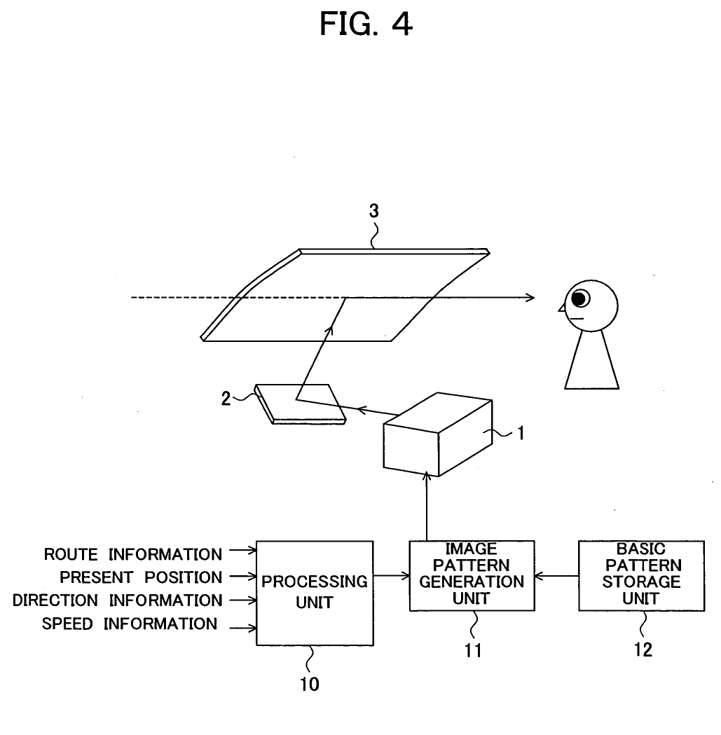

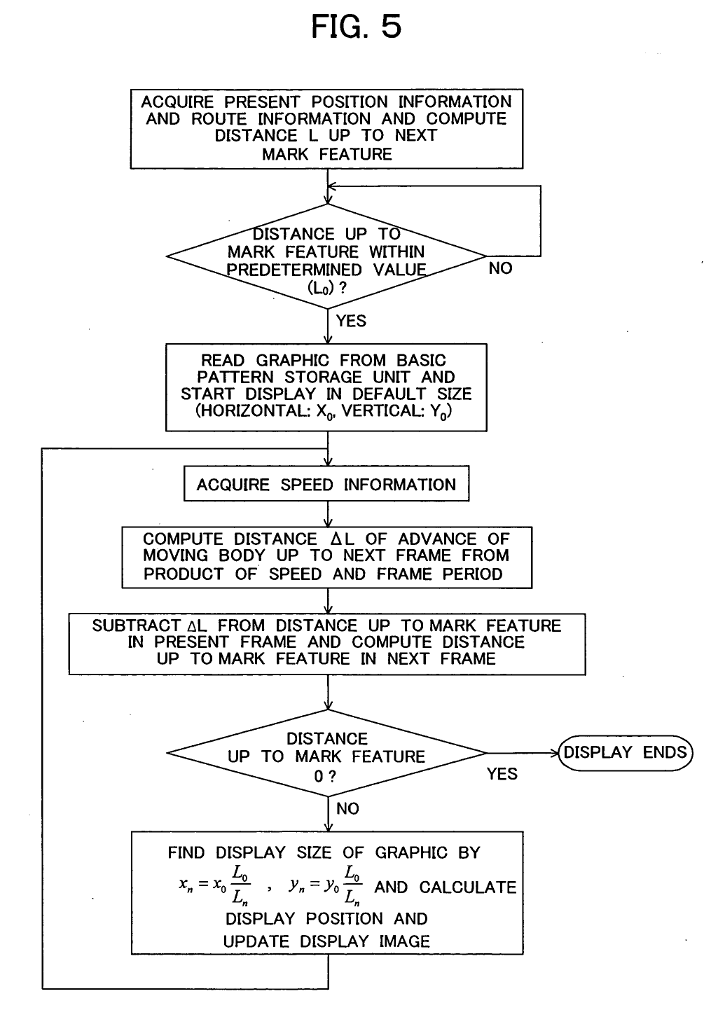

### BRIEF DESCRIPTION OF THE DRAWINGS

[FIG. 1] A diagram showing the basic configuration in a first embodiment of the present invention.

[FIG. 2] A flow chart of processing for determining a size and a display position of a route instruction graphic in the first embodiment of the present invention.

[FIG. 3] Explanatory diagrams of the displayed route instruction graphic in the first embodiment of the present invention, in which FIG. 3A is map information indicating an advance route of a mobile object; FIG. 3B is a route instruction graphic indicating a distant intersection B; and FIG. 3C is a route instruction graphic in a situation where the mobile object approaches the intersection B.

[FIG. 4] A diagram showing the basic configuration in a second embodiment of the present invention.

[FIG. 5] A flow chart of processing for determining the size and the display position of the route instruction graphic in the second embodiment of the present invention.

[FIG. 6] A diagram showing the basic configuration of a heads up display for route guidance.

[FIG. 7] A diagram showing an example of display of the route instruction graphic in a conventional navigation system.

[FIG. 8] A diagram for explaining a problem in the conventional navigation system.

### EXPLANATION OF NOTATIONS

1 display
1a virtual image of display screen
2 optical part or optical system such as concave mirror, convexlens and hologram for extending virtual image position of displayed image of display 1 surface
3 front window
10 processing unit
11 image pattern generation unit
12 basic pattern storage unit
5 route instruction graphic
51 route instruction graphic
100 vehicle
101 forward vehicle
110 route

### BEST MODE FOR WORKING THE INVENTION

First, an explanation will be given of the basic principle of the present invention.

As physiological factors of the human visual system for perceiving depth, as described in Three-Dimensional Image Engineering (Takanori Okoshi, Asakurashoten, 1991), there are the four factors of (1) the binocular parallax, (2) convergence, (3) focal point adjustment, and (4) motion parallax. The depth ranges within which these four factors dominantly function are different.

Focal point adjustment dominantly functions within a range from about 1 to 2 meters in the forward direction, while binocular parallax and convergence are dominant within a range of about 10 meters in the forward direction. At places further from those, the motion parallax dominantly functions in the depth perception.

The present invention was made by paying attention to the point that motion parallax dominantly functions in depth perception of several tens of meters or more which becomes important in the route guidance of a mobile object, particularly a vehicle.

Here, “motion parallax” means that the way a target object is viewed within the field of view becomes different where an observer moves. As a frequently experienced example, the phenomenon that the scenery seen from a window of a train and located far away slowly moves, while the scenery located nearby quickly moves occurs according to the motion parallax.

In the same way, in the view seen across the front window in a vehicle while driving, the scene located far away slowly approaches, and the scene located nearby quickly approaches. When viewing this as an image focused on the retina of the human eye, the image on the retina becomes larger as the driver approaches a target object located in the forward direction, but in this case, the speed that the image size of the target object located far away becomes large is slow and the speed of the image of a target object located nearby becoming large is fast. This phenomenon occurs according to the motion parallax and plays an important role enabling the human visual system to obtain distance information in a remote place where the binocular parallax etc. do not function.

Note that the “motion parallax” means that “the way of viewing a target object becomes different along with the change of the viewing point”, but sometimes the term “motion parallax” is used limiting the change of the viewing point in this case to the change of the viewing point in the orthogonal direction with respect to a straight line connecting the observer and the target object like the change of the scenery seen from the window of a train described above. However, here, the motion parallax is used as a broader definition such as “the way of viewing a target object becomes different along with a change of the viewing point” as it is. A change of the way of viewing a target object according to a change of the viewing point when the observer approaches the target object as in the above example is also called motion parallax.

In the present invention, by conversely utilizing the principle of this motion parallax and changing the rate of change over time of the size of the graphic displayed in a heads up display, the human visual system is made to perceive the graphic as if that graphic existed with a different distance irrespective of the location of that graphic. Then, when the rate of change over time of the size of the graphic is made the same as the rate of change over time of the size of the image on the retina of a feature actually existing at the location where the visual system will be made to perceive that graphic, the human visual system will perceive that the graphic is located at the same position as that of the actually existing feature due to the motion parallax.

For this purpose, it is necessary to change the size of the graphic along with the elapse, i.e., expand the size while ordinary driving. The rate of change over time in that case may be calculated based on the position where the driver is to be made perceive the graphic or that position and the speed of the mobile object.

Further, other than the physiological factors like the motion parallax described before, as a factor of the visual system perceiving the depth, there are psychological factors (also called as experiential factors). The psychological factors are further classified into several factors. It is known that particularly the feeling of depth according to the size of the retinal image among those factors contributes to the acquisition of depth of several tens of meters to several hundreds of meters.

Here, the feeling of depth according to the size of the retinal image means that the visual system senses the approximate distance according to what degree of size a target with a known size is projected onto the retina. Accordingly, the relationship between the distance up to the target object and the displayed size of the target object may be made always constant. In the present invention, the problem is helped to be solved by inducing the effect of depth perception by the visual system according to such a psychological factor.

Below, embodiments of the present invention will be explained in detail by using FIG. 1 to FIG. 5.

FIG. 1 is a diagram showing the basic configuration of a navigation system according to Embodiment 1. FIG. 2 is a flow chart of computation processing for determining the size and the display position of the route instruction graphic in an Embodiment 1. FIG. 3A to FIG. 3C are explanatory diagrams of a route instruction graphic obtained according to the method of Embodiment 1. FIG. 4 is a diagram showing the basic configuration in a navigation system according to Embodiment 2. FIG. 5 is a flow chart of processing for determining the size and the display position of the route instruction graphic in Embodiment 2.

### EMBODIMENT 1

### Embodiment 1

The first embodiment of the present invention is shown in FIG. 1.

In FIG. 1, 1 is a display, and 2 is an optical system for extending the position of a virtual image of a displayed image of the display further away and is constituted by a concave mirror, a convex lens, a hologram, etc. 3 is a front window, 10 is a processing unit for finding the size and the display position of a pattern, 11 is an image pattern generation unit for generating a pattern such as a route instruction graphic displayed on the display 1, and 12 is a basic pattern storage unit for storing the basic pattern used as an initial pattern for the route instruction etc.

In the present embodiment, the size and the display position of the route instruction graphic are determined based on the present position information, route information, and direction information. FIG. 2 shows the flow chart of the processing for determining the size and the display position of the route instruction graphic.

In FIG. 2, the present position information is acquired from the GPS, while further the route information is acquired from the map information recorded in the storage medium mounted in a car etc. The distance up to the next landmark feature for the display of the route instruction graphic such as “turn right” or “turn left” is calculated at the processing unit 10. Then, when the distance up to the next landmark feature becomes within a predetermined distance L0, the corresponding route instruction graphic is retrieve from the basic pattern storage unit and the display is started. The sizes of the route instruction graphic in a horizontal direction and a vertical direction at the time of the start of display are defined as x0 and y0. Thereafter, the present location is acquired for each frame period of the displayed image, the distance up to the landmark feature is computed, and when this distance becomes 0, the display of the route instruction graphic is ended. Alternatively, when the distance is not 0, sizes xn and yn in the horizontal direction and the vertical direction of the route instruction graphic displayed in the next frame image are found according to the following Equation 1.

$$\begin{matrix}[ Equation 1 ] & \\ \begin{matrix}{x}_{n} = {x}_{0} \frac{{L}_{0}}{{L}_{n}} \\ {y}_{n} = {y}_{0} \frac{{L}_{0}}{{L}_{n}}\end{matrix} \} & ( 1 )\end{matrix}$$

Here, Ln is the distance up to the present landmark feature.

This processing is carried out in the processing unit 10, then the result is sent to the image pattern generation unit 11. The image pattern generation unit 11 generates the display pattern based on the received result. The processing unit 10 finds the position of the route instruction graphic to be displayed by the processing based on the direction information of the vehicle. The frame image is generated based on the size and display position of the route instruction graphic obtained by the above method for the display. The above processing flow is carried out for each frame period of the display system, whereby real time display is carried out.

In FIG. 3A to FIG. 3C, FIG. 3A is a diagram showing the present location on the map of a vehicle mounting a navigation system and the route set by the navigation system.

A point C on FIG. 3A is where the vehicle 100 is currently passing. The distance up to the intersection B of the next right turn point is for example 200 meters. At this point C, the display of the route instruction graphic 5 for turning right at the intersection B as shown in FIG. 3B is started. Then, the size of the route instruction graphic at the time after this is calculated according to Equation 1 using the distance between the vehicle and the intersection B at that point of time. According to Equation 1, as shown in FIG. 3C, when the vehicle is passing over the intersection A, in comparison with the point C, the distance up to the intersection B becomes ½. Accordingly the size of the route instruction graphic 51 becomes doubled.

### Embodiment 2

The basic configuration of the navigation system according to the second embodiment of the present invention is shown in FIG. 4. The basic configuration is the same as the basic configuration of the navigation system of Embodiment 1, but in the present embodiment, the size of the route instruction graphic is calculated by utilizing also the speed information of the vehicle acquired from a speed measuring means for speed display in addition to the position information of the vehicle acquired from the GPS.

FIG. 5 is a flow chart of the processing for determining the size and the display position of the route instruction graphic. The processing unit 10, when recognizing that the distance up to the landmark feature approaches a predetermined distance from the position information and route information of the vehicle acquired from the GPS, retrieves the route instruction graphic from the basic pattern storage unit 12 and starts the display. The sizes of the route instruction graphic in the horizontal direction and vertical direction at the time of the start of display are defined as x0 and y0. In the display after that, it is assumed that an n−1-th frame image is displayed in the display, and the processing unit 10 generates the route instruction graphic displayed in an n-th frame image.

First, the present speed of the vehicle is obtained, then this is multiplied by the frame period to calculate a distance ΔL of advance of the vehicle from the n−1-th frame to the n-th frame period. Then, this ΔL is subtracted from a distance Ln up to the landmark feature in the n−1-th frame to calculate the distance Ln up to the landmark feature in the n-th frame. When this distance becomes 0, the display of the route instruction graphic is ended, while when that distance is not 0, the size of the route instruction graphic displayed in the next frame image is found according to Equation 1.

This processing is carried out at the processing unit 10, then the result thereof is sent to the image pattern generation unit 11. The image pattern generation unit 11 generates the display pattern based on the received result. Further, the processing unit 10 finds the position of the route instruction graphic to be displayed from calculation based on the direction information of the vehicle. The frame image is generated and the display is carried out based on the size and the display position of the route instruction graphic obtained by the above method. The above processing flow is carried out for each frame period of the display system, whereby real time display is carried out.

The basic idea of the present invention is to utilize the fact that when the rate of change over time of the size of a graphic displayed in the forward direction of the front window is made the same as the rate of change over time of the size of the image on the retina of a feature actually existing at the position where the visual system is to be made perceive that figure according to the motion of the car, when the displayed graphic is further away than a certain distance, the visual system perceives that the graphic is located at the same position as that of the feature according to the motion parallax irrespective of the actual position of the graphic so long as the displayed graphic is located further away than a certain distance.

The present invention, needless to say, is not limited to the two embodiments explained above. Various modifications are possible within a range not out of the spirit of the present invention. For example, as the means for acquiring the position of the vehicle, the GPS was utilized in the above embodiments, but it is also possible to use the position information obtained from the image of the scene around the car by a CCD camera etc. mounted in the car.

Note that, in the present invention, irrespective of the difference of the embodiments, by making the position of the virtual image of the displayed image of the display ahead by 10 meters or more from the front window, a remarkable effect can be obtained. This is because the present invention utilizes the factor of motion parallax among the physiological factors used when the human visual system perceives the depth of a target object, but the motion parallax becomes more dominant than the other factors from a region of approximately 10 meters or more.

The indicator display system may be any one making the indicator image having a constant positional relationship relative to features around the mobile object overlap the scene on a transparent member which passes the light from the surroundings of the mobile object and through which the view of the surroundings of the mobile object can be viewed by the user in the mobile object and is not limited to a navigation system. For example, the indicator display system may be one displaying an indicator image designating a feature in the surroundings on the window glass of a passenger liner or a ride in an amusement park to increase the enjoyment of the passengers.

The transparent member on which the route instruction graphic is displayed may be any one allowing light from the surroundings of a mobile object to pass and enable viewing of the scenery of the surroundings of the mobile object from a user in the mobile object and is not limited to a front window. For example, it may be a window glass at the back with respect to the traveling direction or may be formed by resin such as plastic. Note that where the indicator image is displayed to the back in the traveling direction of the mobile object, the indicator image becomes small along with the movement of the mobile object.

The increase of the size of the indicator image along with the reduction of the distance between the mobile object and the landmark feature or the reduction of the size of the indicator image along with the increase of the distance between the mobile object and the landmark feature is not limited to the change of the size of the indicator image in inverse proportion to the change of the distance between the mobile object and the landmark feature and for example may be made larger or smaller than the inverse proportional size.

The display system for displaying the route instruction graphic on the transparent member is not limited to one constituted by a heads up display. For example, the transparent member per se may be provided a built-in liquid crystal and applied voltage, and the transparent member per se may be made function as the display.

The change of the size of the route instruction graphic displayed on the transparent member may be accomplished by the image generation unit or may be accomplished by the display system. For example, in a display system constituted by a heads up display, the size of the route instruction graphic displayed on the front window may be changed by driving the optical system for projecting the image displayed in the display onto the front window.

In each embodiment, needless to say a computer can be made execute the processing sequence for the image display executed in the processing means, and it is possible to store a program for making the computer run the processing sequence in a storage medium which can be read by that computer, for example, a flexible magnetic disc, optical disc, ROM, memory card, CD, DVD, or removable disc, and provide and distribute the same.

1. A navigation system displaying an image (including graphics, letters, and symbols) so as to overlap a view seen in a forward direction of a front window provided in a mobile object wherein the image is displayed to a driver while changing a size of at least one graphic (including symbols and letters) in the image along with the elapse along with movement of the mobile object.

2. A navigation system forming an image of a displayed image of a display mounted in a mobile object on a front window provided in the mobile object on an opposite side to a driver's seat so as to display the displayed image of the display to the driver of the mobile object, wherein the image is displayed to a driver while changing a size of at least one graphic (including symbols and letters) in the image along with the elapse along with movement of the mobile object.

3. A navigation system reflecting a part of light emitted from a display surface of a display mounted in the mobile object at a front window of the mobile object and forming a virtual image of the displayed image of the display in the direction ahead of the front window so as to display the image to the driver of the mobile object, wherein the image is displayed to a driver while changing a size of at least one graphic (including symbols and letters) in the image along with the elapse along with movement of the mobile object.

4. A navigation system as set forth in any one of claims 1 to 3, wherein the size of said graphic is calculated based on position information of the mobile object, and wherein the position of formation of said graphic is a position 10 meters or more ahead of the front window provided in the mobile object in the forward direction.

5. A navigation system as set forth in any one of claims 1 to 3, wherein the size of said graphic is calculated based on the position information of the mobile object and a movement speed of the mobile object, and wherein the position of formation of said graphic is a position 10 meters or more ahead of the front window provided in the mobile object in the forward direction.

6. (canceled)

7. An indicator image display system enabling a user in a mobile object to view an indicator image by overlapping the indicator image on the view of the surroundings of said mobile object as seen through a transparent member, comprising:
an image generation unit generating said indicator image,
a display system displaying the indicator image generated by said image generation unit and overlapping said indicator image on the view of the surroundings of said mobile object on said transparent member so that the indicator image and a landmark feature seen through said transparent member have a constant positional relationship, and
a processing unit computing a distance from said mobile object to said landmark feature and controlling an operation of at least one of said image generation unit and said display system so as to increase the size of said indicator image overlapped on said transparent member along with a reduction of said computed distance along with movement of said mobile object.

8. An indicator image display system enabling a user in a mobile object to view an indicator image by overlapping the indicator image on the view of the surroundings of said mobile object seen through a transparent member, comprising:
an image generation unit generating said indicator image,
a display system displaying the indicator image generated by said image generation unit and overlapping said indicator image on the view of the surroundings of said mobile object on said transparent member so that the indicator image and a landmark feature seen through said transparent member have a constant positional relationship, and
a processing unit computing a distance from said mobile object to said landmark feature and controlling an operation of at least one of said image generation unit and said display system so as to reduce the size of said indicator image overlapped on said transparent member along with an increase of said computed distance along with movement of said mobile object.

9. An indicator image display system as set forth in claim 7, wherein said processing unit controls the operation of at least one of said image generation unit and said display system so that the display of said indicator image is started when the distance from said mobile object to said landmark feature becomes within a predetermined threshold value and so that the size of said indicator image when the display is started becomes constant.

10. An indicator image display system as set forth in claim 9, wherein
said system is further comprising a storage unit for storing a basic pattern of said indicator image, and
said processing unit controls the operation of at least one of said image generation unit and said display system so as to generate an image having a size of the size of said basic pattern multiplied by a ratio of the distance from said mobile object to said landmark feature with respect to said threshold value.

11. An indicator image display system as set forth in any one of claims 7 to 10, wherein said processing unit controls the operation of at least one of said image generation unit and said display system so as to display said indicator image when the distance to said landmark feature is within a predetermined threshold value, and said threshold value is a position away from said transparent member by 10 meters or more.
